(19) United States
(12) Patent Application Publication
(10) Pub. No.: US 2026/0172667 A1
(43) Pub. Date: Jun. 18, 2026

(54) DISPLAYING ANIMATIONS BASED ON SUBJECT FACIAL EXPRESSION DURING IMAGE CAPTURE IN AN ELECTRONIC DEVICE

(71) Applicant: MOTOROLA MOBILITY LLC, WILMINGTON, DE (US)

(72) Inventors: RANJEET GUPTA, Aurora, IL (US); RAHUL BHARAT DESAI, Hoffman Estates, IL (US); DANIEL M VACURA, Chicago, IL (US)

(21) Appl. No.: 18/986,672

(22) Filed: Dec. 18, 2024

(51) Int. Cl. H04N 23/63; G06V 10/98; G06V 40/16; H04N 23/60; H04N 23/611

(52) U.S. Cl. CPC H04N 23/632; H04N 23/611; H04N 23/64; G06V 10/987; G06V 40/175

(57) ABSTRACT

An electronic device, a method and a computer program product enable selection of an animation to present during image capturing based on subject facial expression. The method includes presenting a first animation on a display to attract the attention of an individual whose image is to be captured. The method includes extracting a preview image from a preview image stream and determining if the preview image contains the face of the individual with a facial expression that is an acceptable facial expression for initiating capture of a persistent image. In response to determining that the facial expression of the individual is not an acceptable facial expression, the method includes selecting a second animation from among a plurality of animations. The second animation is selected to prompt the individual to respond with a different facial expression. The method includes presenting the second animation on the display.

### BACKGROUND

### 1. Technical Field

The present disclosure generally relates to electronic devices and in particular to capturing images in an electronic device.

### 2. Description of the Related Art

Electronic devices, such as mobile phones, tablets, and laptops, are widely used for video, voice, and text communication and for data transmission. Many conventional electronic devices have at least one front facing camera and one or more rear facing cameras. Electronic devices with cameras can be used to capture various images within a field of view of the camera. An electronic device user can choose to capture an image of friends, objects, scenery, or themselves using one of the cameras.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices and several image capturing devices, according to one or more embodiments;

FIG. 2A is an example illustration of the front of an electronic device with a front display and multiple front cameras, according to one or more embodiments;

FIG. 2B is an example illustration of the rear of an electronic device with a rear display and multiple rear cameras, according to one or more embodiments;

FIG. 3 is a block diagram of example contents of the memory subsystem of the example electronic device of FIG. 1A-1B (FIG. 1), which configures the electronic device to complete the various processes described herein, according to one or more embodiments;

FIG. 4A illustrates an example of an electronic device in an image capturing mode with a subject whose image is to be captured in a field of view of a rear camera, according to one or more embodiments;

FIG. 4B illustrates an example of the subject, whose image is to be captured, viewing a first animation presented on a rear display of the electronic device, according to one or more embodiments;

FIG. 5A illustrates an example of an image of a face of the subject with a frowning facial expression deemed to not be suitable for capturing a persistent image, according to one or more embodiments;

FIG. 5B illustrates an example of an image of a face of the subject with an acceptable facial expression to capture a persistent image, according to one or more embodiments;

FIG. 6A illustrates an example second animation presented on a rear display of the electronic device, in response to detecting the frowning facial expression, according to one or more embodiments;

FIG. 6B illustrates an example third animation presented on a rear display of the electronic device, according to one or more embodiments; and

FIGS. 7A-7B depict a flowchart of a method by which an electronic device selects at least one animation to present during image capturing, based on subject facial expression, according to one or more embodiments.

### DETAILED DESCRIPTION

According to one or more aspects of the present disclosure, the illustrative embodiments provide an electronic device, a method, and a computer program product for enabling selection of at least one animation to present during image capturing, based on subject facial expression. An electronic device can determine if a preview image contains the face of an individual with a facial expression that is an acceptable facial expression for initiating capture of a persistent image of the individual. The acceptable facial expression can be a smiling facial expression. In response to determining that the facial expression of the individual is not an acceptable facial expression, the electronic device selects an animation from among several animations and presents the selected animation on a display to prompt the individual to respond with a different facial expression.

An electronic device can display an animation, such as a cartoon, on a display during a photograph capturing process. The animation can be a fun and entertaining presentation that attracts the attention of people being photographed. The animation can encourage people being photographed, and particularly children being photographed, to look directly at the camera. Unfortunately, oftentimes the animation fails to persuade the person/people being photographed to smile or to pose with a smiling facial expression. This is especially a problem when the same animation is repeated over and over for each photograph. Capturing images where people are not smiling or have unflattering facial expressions can be irritating and frustrating for the user of the electronic device.

The embodiments disclosed herein addresses and overcome the aforementioned problems of an electronic device with a camera that is used to photograph people. One or more aspects of the embodiments disclosed herein enable an electronic device to determine if a subject whose image is being captured has a facial expression that is an acceptable facial expression for capturing an image of the subject. The embodiments disclosed herein further enable the electronic device to select an animation from among several animations and present the animation on a display to prompt the individual to respond with a different facial expression. The embodiments disclosed herein enable the electronic device to autonomously capture an image, when the subject whose image is being captured has an acceptable facial expression, such as a smiling facial expression.

In a first embodiment, an electronic device includes at least one camera including a first camera having a first field of view (FOV), at least one display including a first display oriented in a common first direction with the first FOV of the first camera, and a memory having stored thereon an animation selection and image capture (ASIC) module for enabling selection of at least one animation to present during image capturing. The electronic device includes at least one processor that is communicatively coupled to each of the at least one display, the at least one camera, and the memory, and which executes program code of the ASIC module. The at least one processor is configured to cause the electronic device to, while the electronic device is in a first image capturing mode using the first camera, present a first animation, from among a plurality of animations, on the first display. The first animation presented is intended to attract the attention of at least one first individual whose image is to be captured. The at least one processor extracts a first preview image from a first preview image stream being captured via the first camera. The at least one processor determines if the first preview image contains the face of the at least one first individual with a first facial expression that is an acceptable facial expression for initiating capture of a first persistent image of the at least one first individual. In response to determining that the first facial expression of the at least one first individual is not an acceptable facial expression for initiating capture of the first persistent image, the at least one processor selects a second animation from among the plurality of animations. The second animation is selected to prompt the at least one first individual to respond with a different facial expression. The at least one processor presents the second animation on the first display.

According to another embodiment, the method includes, while the electronic device is in a first image capturing mode using a first camera, presenting, via at least one processor, a first animation from among a plurality of animations on a first display. The first animation presented is intended to attract the attention of at least one first individual whose image is to be captured. The method includes extracting a first preview image from a first preview image stream being captured via the first camera. The method includes determining if the first preview image contains the face of the at least one first individual with a first facial expression that is an acceptable facial expression for initiating capture of a first persistent image of the at least one first individual. In response to determining that the first facial expression of the at least one first individual is not an acceptable facial expression for initiating capture of the first persistent image, the method includes selecting a second animation from among the plurality of animations. The second animation is selected to prompt the at least one first individual to respond with a different facial expression. The method includes presenting the second animation on the first display.

According to an additional embodiment, a computer program product includes a computer readable storage device having stored thereon program code that, when executed by at least one processor of an electronic device having at least one camera and at least one display, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

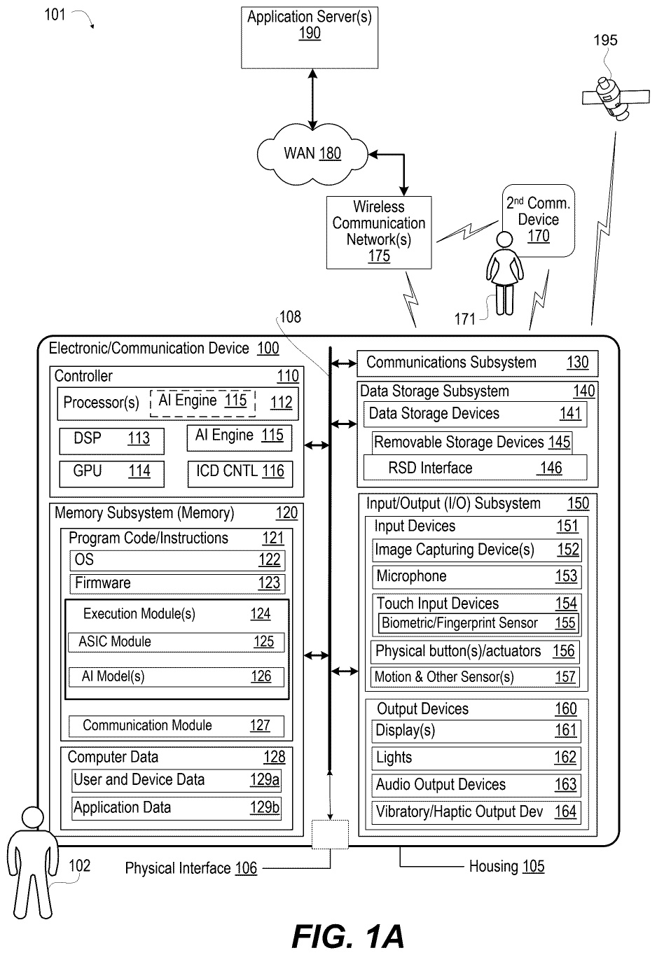

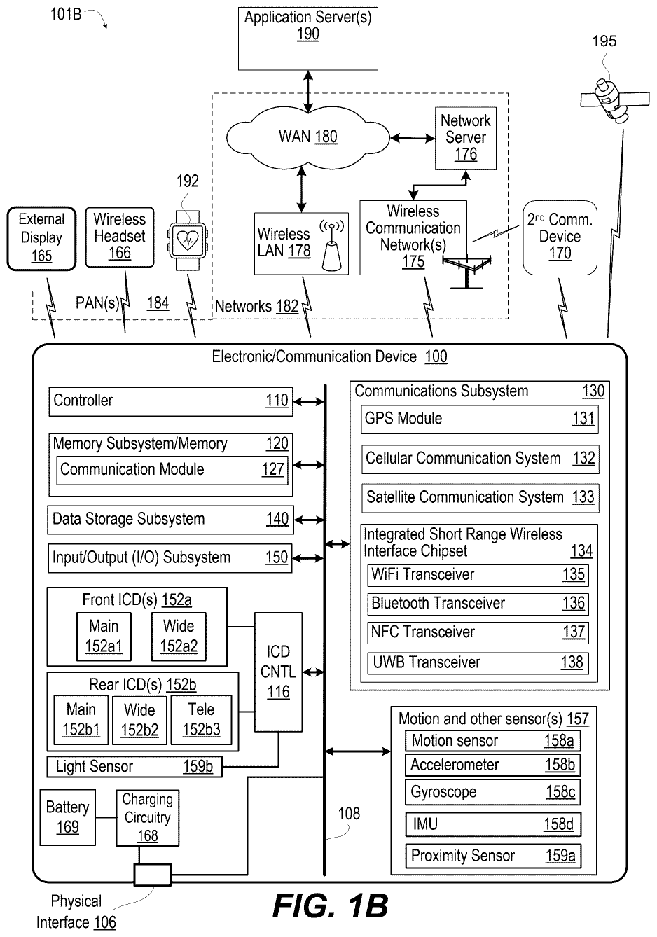

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in a communication environment 101 and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown).

Controller 110 manages, and in some instances directly controls, the various functions and/or operations of communication device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) include instructions for an operating system (OS) 122, firmware 123, such as basic input/output system (BIOS) or Uniform Extensible Firmware Interface (UEFI). Program code 121 includes execution module(s) 124 that collectively provides the various features of the disclosure.

Execution module(s) 124 include, without limitation, animation selection and image capture (ASIC) module 125. ASIC module 125 provides the features and operating functionality of the disclosed embodiments when the corresponding program instructions of ASIC module 125 are processed by/within processor 112/controller 110. Specifically, ASIC module 125 provides program instructions for selecting at least one animation to present during image capturing.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within ASIC module 125 and is trained to support the AI features of ASIC module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data. In the present disclosure, AI model(s) 126 are trained to detect when a facial expression of a subject is not acceptable for taking a persistent image and are also trained to parse through a database or stored collection of animations that are predicted to cause a positive response in the facial expression of a viewer of the animation.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identify the underlying features performed by processing the different modules. For example, ASIC module 125 can include program instructions that cause or configure processor 112 to cause electronic device 100 to select at least one animation based on subject facial expression to present during image capturing. Other features provided by ASIC module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of communication device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of ASIC module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, inertial measurement unit (IMU) 158d, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. IMU 158d measures force, angular rate, and orientation of electronic device 100, using a combination of accelerometers, gyroscopes, and magnetometers.

Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located or disposed on a rear surface of housing 105. Other embodiments provide for multiple integrated displays within electronic device 100 and references to display(s) 161 are assumed to refer to one or all of these multiple integrated displays.

Vibration/haptic output device 164 can cause electronic device 100 to vibrate or shake when activated. Vibration device 164 can be activated during an incoming call or message in order to provide an alert or notification to a user of electronic device 100. Audio output devices (e.g., a speaker) 163 can provide an audio alert or other audio output to a user. In one or more embodiments, integrated display 161, audio output devices (or speakers) 163, and vibration/haptic device 164 can generally and collectively be referred to as output devices.

With reference now to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone that is used by a second user 171, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of ASIC module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can also be used as a power supply port that is coupled to charging circuitry 168, which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 include front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera 152a1 and a wide angle camera 152a2. Rear cameras can include a main camera 152b1, a wide angle camera 152b2, and a telephoto camera 152b3. Both sets of cameras 152 include image sensors that can capture images that are within the field of view (FOV) of each respective camera 152. In one or more embodiments, one or more of the cameras can be utilized to enable biometric authentication using facial image or iris scan recognition.

In one embodiment, main cameras 152a1 and 152b1 can be low resolution (i.e., a low number of pixels) always on cameras (AoC) that continuously capture images and have a low level of power consumption. Wide angle cameras 152a2, 152b2, and telephoto camera 152b3 can be high resolution cameras (i.e., a high number of pixels) that only capture images when triggered and have a higher level of power consumption.

In the description of each of the following figures, reference is also made to specific components illustrated within the preceding figure(s). Similar or same components are presented with the same leading reference number.

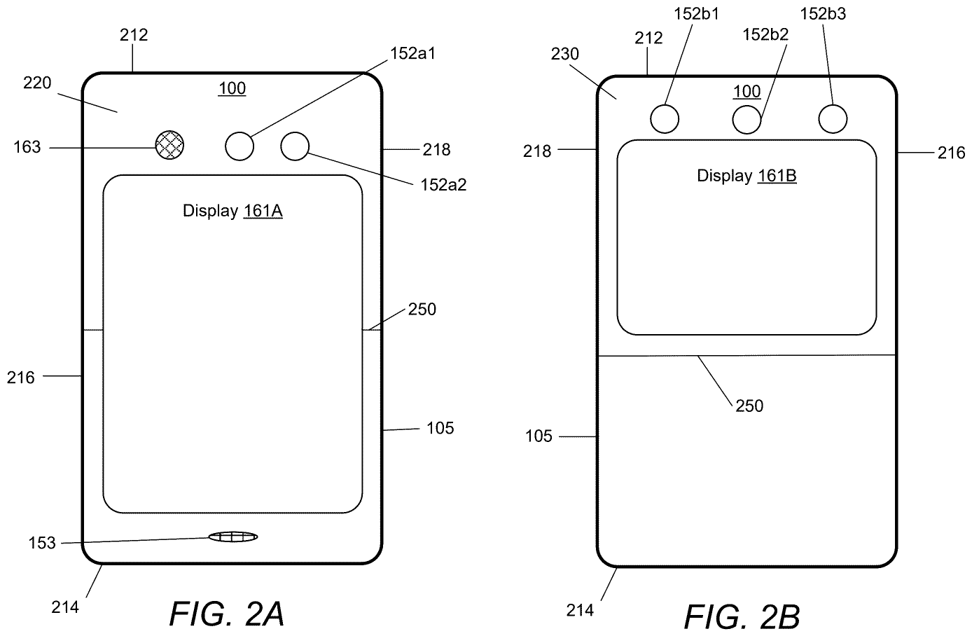

Turning to FIG. 2A, additional details of the front surface of electronic device 100 are shown. Electronic device 100 includes a housing 105 that contains the components of electronic device 100. Housing 105 includes a top 212, bottom 214, and opposed sides 216 and 218. Housing 105 further includes a front surface 220. Electronic device 100 includes a front display 161A. In some implementations, microphone 153, front display 161A, front cameras 152a1, 152a2 and audio output devices 163 are at least partially integrated or disposed into front surface 220. In one embodiment, electronic device 100 can be a foldable electronic device that folds in half along a hinge 250.

With additional reference to FIG. 2B, additional details of the rear surface of electronic device 100 are shown. Housing 105 further includes a rear surface 230. Electronic device 100 includes a rear display 161B. Various components of electronic device 100 are located or disposed on/at rear surface 230, including several rear cameras. In some implementations, rear display 161B, rear main camera 152b1, rear wide angle camera 152b2, and rear telephoto camera 152b3 are at least partially integrated or disposed into rear surface 230. In one embodiment, electronic device 100 can fold in half along hinge 250. In the folded position, rear surface 230 becomes an outer surface of electronic device 100.

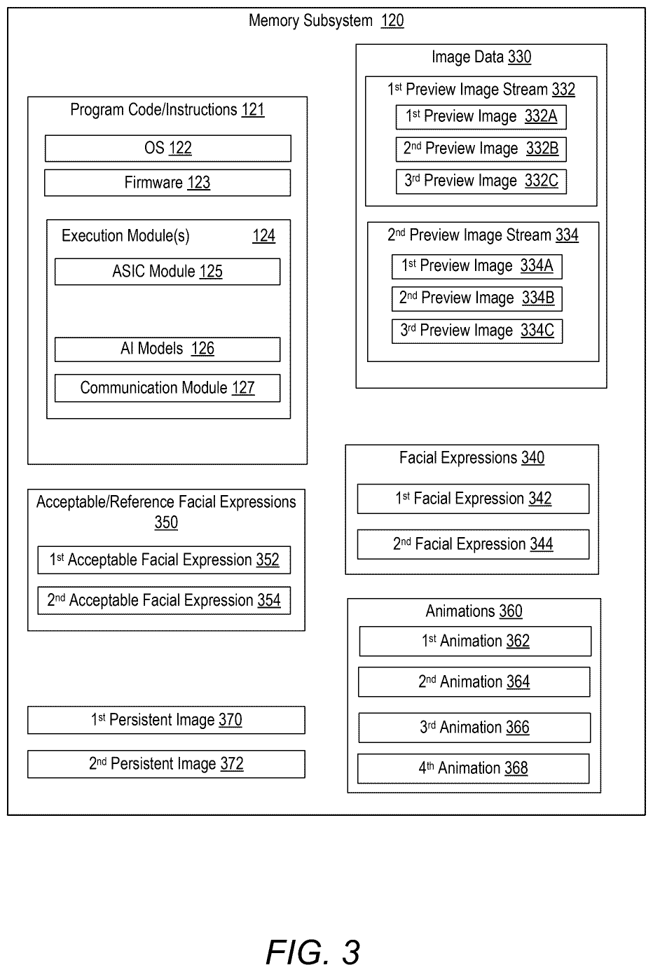

Referring to FIG. 3, there is shown one embodiment of example contents of memory subsystem 120 of electronic device 100. In the described embodiments, the contents of the memory are utilized to and/or configure electronic device 100 to complete the various processes described herein. Memory subsystem 120 includes program code/instructions 121 including data, software, and/or firmware modules, such as operating system (OS) 122, firmware 123, and execution module(s) 124. Execution module(s) 124 include ASIC module 125, AI models 126, and communication module 127.

ASIC module 125 includes program code that is executed by processor 112 to enable electronic device 100 to perform the various features of the present disclosure. In one or more embodiments, ASIC module 125 enables electronic device 100 to select at least one animation from a plurality of animations based on facial expression to present during image capturing.

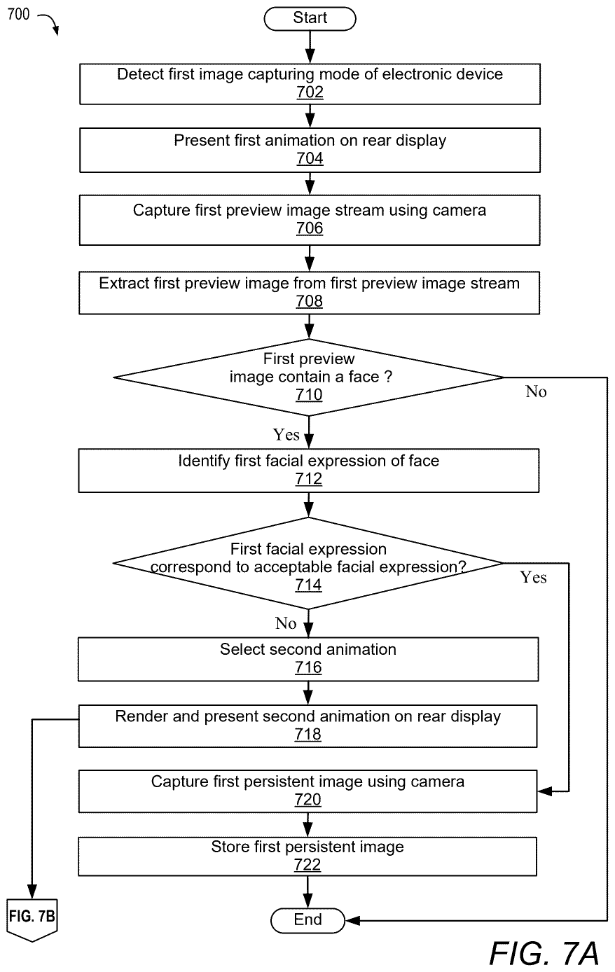

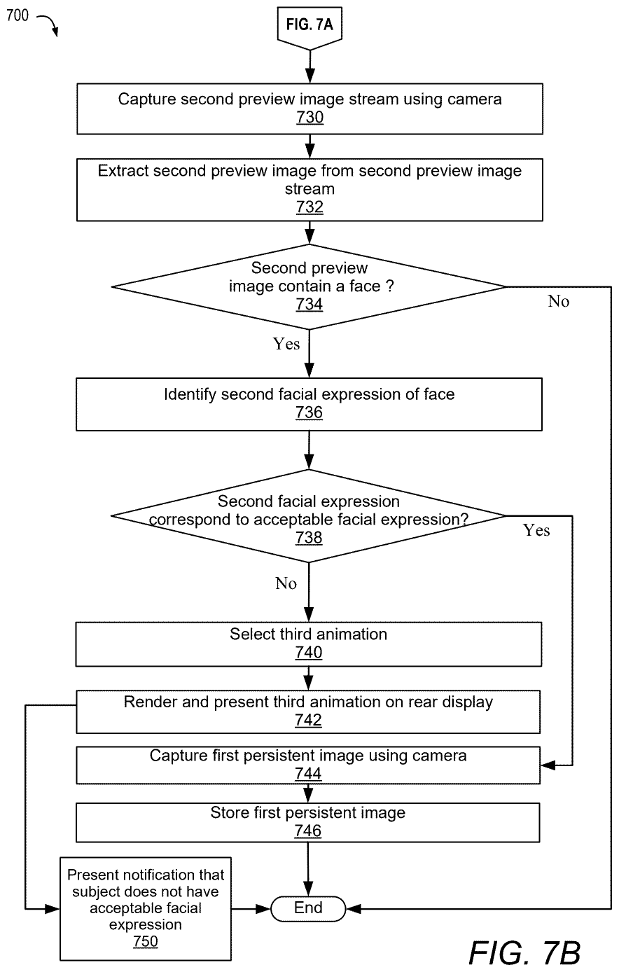

In one or more embodiments, execution of ASIC module 125 by processor 112 configures electronic device 100 to perform the processes presented in the flowchart of FIGS. 7A-7B, as will be described below. AI models 126 accelerate artificial intelligence, natural language processing (NLP), context evaluation (CE), and machine learning applications. Communication module 127 enables electronic device 100 to communicate and exchange data with other devices via networks 182.

Memory subsystem 120 includes image data 330. Image data 330 can be captured by one or more cameras 152 of electronic device 100. Image data 330 includes first preview image stream 332 and second preview image stream 334. In one embodiment, first preview image stream 332 and second preview image stream 334 can comprise multiple frames of images that are captured over a period of time. For example, first preview image stream 332 includes first preview image 332A, second preview image 332B and third preview image 332C. Second preview image stream 334 includes first preview image 334A, second preview image 334B and third preview image 334C.

Memory subsystem 120 includes facial expressions 340. Facial expressions 340 correspond to the facial expression(s) of an individual or subject whose image is to be captured by one of cameras 152 of electronic device 100. Facial expressions 340 include a first facial expression 342 and a second facial expression 344. Examples of facial expressions can include a frowning facial expression, a smiling facial expression, a surprised facial expression, a sad facial expression, and a happy facial expression. In one embodiment, first facial expression 342 is determined by processing the first preview image 332A containing the face of the at least one individual through an artificial intelligence engine (i.e., AI models 126) to identify the first facial expression 342 of the at least one individual.

Memory subsystem 120 includes acceptable/reference facial expressions 350. Acceptable/reference facial expressions 350 are facial expressions that are preferred or desired for capturing an image of a person. Acceptable/reference facial expressions 350 include first acceptable facial expression 352 and second acceptable facial expression 354. In one embodiment, the acceptable/reference facial expressions 350 can be smiling facial expression and happy facial expression.

Memory subsystem 120 includes animations 360. Animations 360 include one or more of movies, films, scenes, or sequences that simulate movement from a series of still frames such as drawings, computer graphics, or photographs. In one embodiment, animations 360 can be a cartoon featuring an exaggerated visual style with animated characters. Animations 360 include first animation 362, second animation 364, third animation 366, and fourth animation 368. It is appreciated that animations 360 can include more or fewer than four animations.

Memory subsystem 120 includes first persistent image 370 and second persistent image 372. First persistent image 370 and second persistent image 372 are images that are not temporary and are designated for retention or saving in memory subsystem 120. In one example embodiment, persistent images 370, 372 can be automatically captured by electronic device 100 after determining that an individual whose image is to be captured has a smiling facial expression. In alternate embodiments, persistent images 370, 372 can be manually captured by a user depressing a physical button on an external surface of the device or selecting a virtual image capture icon located on the device display screen.

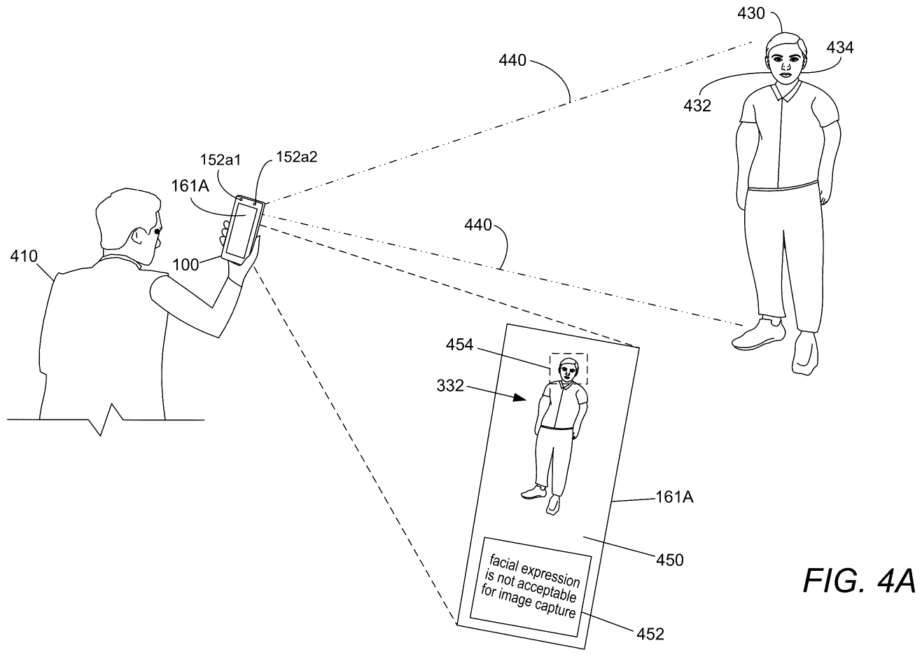

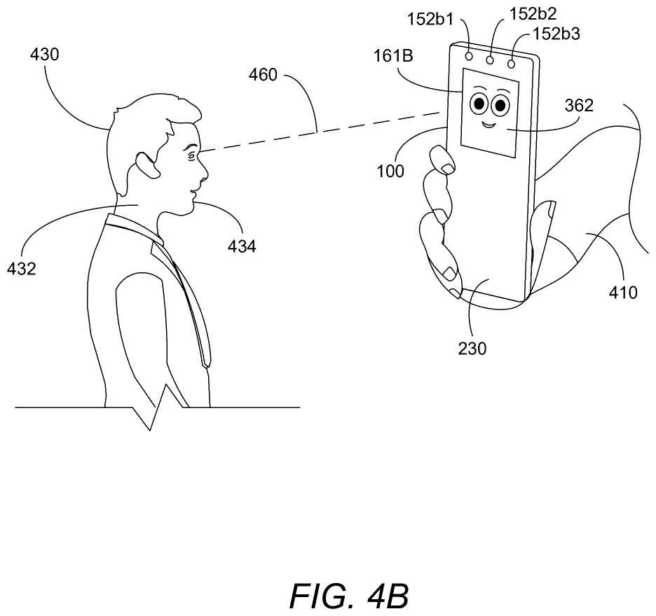

Referring to FIG. 4A, electronic device 100 has been positioned by electronic device user 410 such that the rear cameras 152b1, 152b2, and 152b 3 and rear display 161B face a subject or individual 430 whose image is to be captured. Electronic device user 410 can view front display 161A. Individual 430 has a face 432 with a facial expression 434. Rear main camera 152b1 has a FOV 440 that can capture a first preview image stream 332 including a first preview image 332A that contains the face 432 of the individual 430 whose image is to be captured.

Turning to the enlarged view of front display 161A in FIG. 4A, electronic device 100 is shown presenting a first graphical user interface (GUI) 450 on front display 161A. The first GUI 450 includes at least a portion of the first preview image stream 332 captured via the rear main camera 152b1 and a first notification or indicator 452 identifying the at least one first individual 430 whose image is to be captured does not have the first facial expression that corresponds to an acceptable facial expression for initiating image capture.

In one embodiment, when multiple individuals are within the first preview image stream, the first notification or indicator 452 can identify each specific individual that does not have an acceptable facial expression for initiating image capture. In another example embodiment, the indicator can be a box 454 that surrounds the faces of the individuals that do not have an acceptable facial expression for initiating image capture. Other methodologies for identifying specific individuals from among the group of individuals are contemplated and fall within the scope of this disclosure.

With reference to FIG. 4B, subject or individual 430 is shown looking at rear display 161B of electronic device 100 along an eye gaze direction 460. Electronic device 100 is being held by electronic device user 410 such that the rear cameras 152b1, 152b2, and 152b3 and rear display 161B face individual 430 whose image is to be captured. Rear display 161B is shown presenting a first animation 362 to attract the attention of an individual 430 to look toward rear main camera 152b1. In one embodiment, first animation 362 can be a smiling face cartoon with a large pair of eyes. In an embodiment, various animations can be presented on rear display 161B in order to prompt individual 430 to pose with an acceptable facial expression, such as a smiling facial expression when electronic device 100 is in an image capturing mode using one of the rear cameras 152. Other information can also be presented on rear display 161B such as a message asking individual 430 to smile.

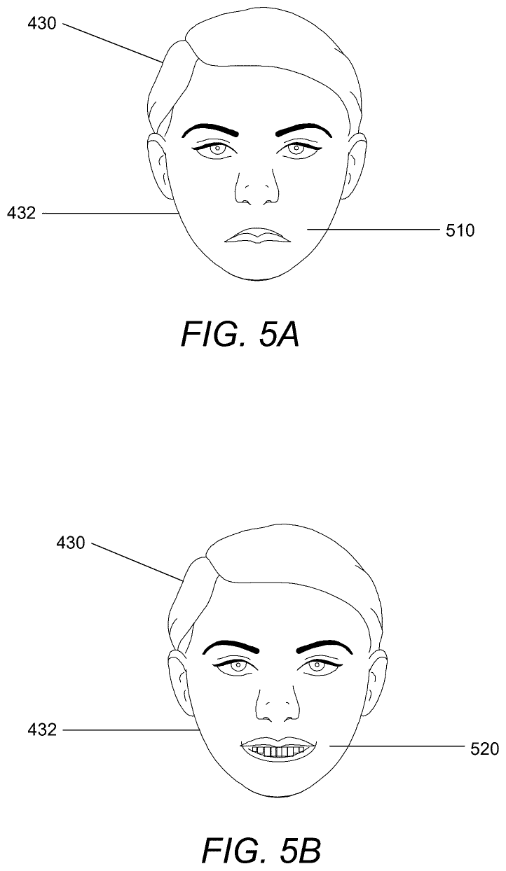

FIG. 5A illustrates the face 432 of individual 430 with a frowning facial expression 510. Electronic device 100 can determine if a first preview image 332A contains a face 432 of an individual and can identify the type of facial expression (e.g., frowning facial expression 510). Frowning facial expression 510 can correspond to the type of first facial expression 342.

According to one aspect of the disclosure, electronic device 100 can process the first preview image 332A containing the face 432 of the at least one individual 430 through an artificial intelligence engine 115 and/or AI models 126 to identify the first facial expression 342 (e.g., frowning facial expression 510) of the at least one individual. Electronic device 100 can identify various facial expressions of individual 430 such as a smiling facial expression, a surprised facial expression, a sad facial expression, and a happy facial expression.

FIG. 5B illustrates the face 432 of individual 430 with a smiling facial expression 520. In one embodiment, smiling facial expression 520 corresponds to at least one acceptable first facial expression 352 (FIG. 3) from among a plurality of acceptable facial expressions 350 for initiating capture of a first persistent image 370 of the individual 430 via rear main camera 152b1. According to one aspect of the disclosure, an acceptable first facial expression 352 for initiating capture of a first persistent image 370 corresponds to a smiling facial expression (e.g., smiling facial expression 520).

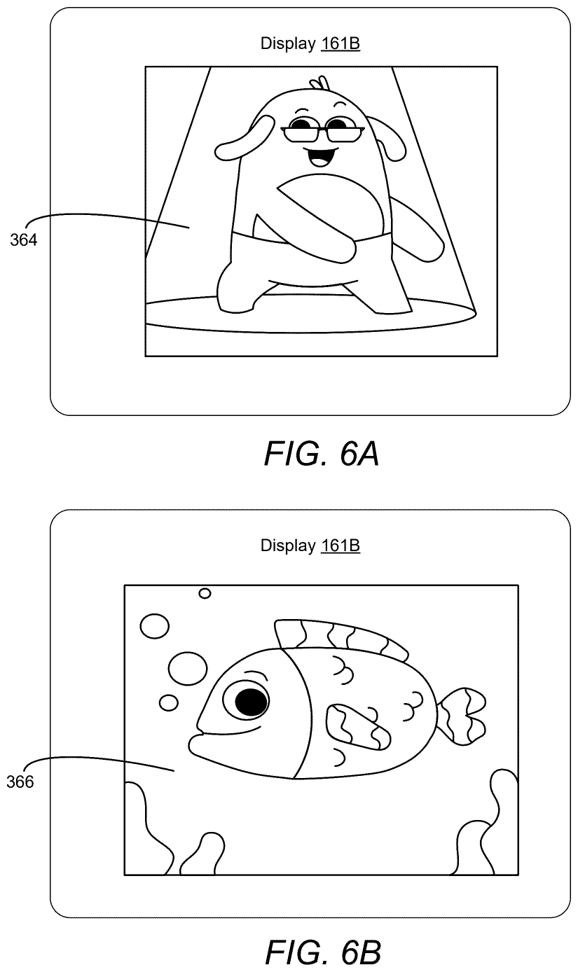

Referring to FIG. 6A, rear display 161B of electronic device 100 is shown presenting a second animation 364. In FIG. 6A, the second animation 364 is shown as an animated character performing under a spotlight. Second animation 364 can be shown to the individual 430 whose image is being captured in order to encourage the individual to change their facial expression to an acceptable facial expression 350 for image capture. The second animation 364 is selected to prompt the individual 430 to respond with a different facial expression that their current facial expression (i.e., first facial expression 342). In one embodiment, second animation 364 is randomly selected from among the plurality of animations 360 that can be presented.

Referring to FIG. 6B, rear display 161B of electronic device 100 is shown presenting a third animation 366. In FIG. 6B, the third animation 364 is shown as an animated fish in an underwater environment. Third animation 366 can be shown to the individual 430 whose image is being captured in order to encourage the individual to change their facial expression to an acceptable facial expression 350 for image capture. The third animation 366 is selected to prompt the individual 430 to respond with a different facial expression that their current facial expression (i.e., second facial expression 344). In one embodiment, third animation 366 is randomly selected from among the plurality of animations 360 that can be presented. In another embodiment, AI model(s) 126 can identify individual 430 from a database of previously captured images and select the animation, from the plurality of animations 360 that are most likely to cause a positive response (i.e., a smile) in the facial expression of a viewer of the animation.

According to one aspect of the disclosure, while electronic device 100 is in a first image capturing mode using rear main camera 152b1, electronic device 100 presents a first animation 362 from among a plurality of animations 360 on rear display 161B. The first animation 362 is intended to attract the attention of at least one first individual 430 whose image is to be captured. Electronic device 100 extracts a first preview image 332A from a first preview image stream 332 being captured via the rear main camera 152b1. Electronic device 100 determines if the first preview image 332A contains the face 432 of the at least one first individual 430 with a first facial expression 342 that is an acceptable facial expression for initiating capture of a first persistent image 370 of the at least one first individual. In response to determining that the first facial expression 342 of the at least one first individual is not an acceptable facial expression for initiating capture of the first persistent image 370, electronic device 100 selects a second animation 364 from among the plurality of animations 360. The second animation 364 is selected to prompt the at least one first individual 430 to respond with a different facial expression. Electronic device 100 presents the second animation 364 on the rear display 161B.

According to another aspect of the disclosure, to determine if the first preview image 332A contains the face 432 of the at least one first individual 430 with the first facial expression 342, electronic device 100 identifies that the face 432 of the at least one first individual 430 is captured within the first preview image 332A. Electronic device 100 analyzes, using comparative facial expression data, the first facial expression 342 of the at least one first individual to determine if the first facial expression 342 of the at least one first individual corresponds to at least one acceptable first facial expression 352 from among a plurality of acceptable facial expressions 350. In response to determining that the first facial expression 342 of the at least one individual corresponds to the at least one acceptable facial expression 352 from among the plurality of acceptable facial expressions 350. Electronic device 100 initiates capture of the first persistent image 370 of the at least one first individual via the rear main camera 152b1.

According to one more aspect of the disclosure, following a rendering and presenting of the second animation 364 on the rear display 161B, electronic device 100 captures a second preview image 334A, using the rear main camera 152b1. Electronic device 100 identifies a second facial expression 344 of the at least one first individual 430 from the second preview image 334B. Electronic device 100 determines if the second facial expression 344 of the at least one first individual is an acceptable facial expression for initiating capture of the first persistent image 370 of the at least one first individual. In response to determining that the second facial expression 344 of the at least one first individual is not an acceptable facial expression, electronic device 100 selects a third animation 366 from among the plurality of animations 360. Electronic device 100 presents the third animation 366 on rear display 161B.

According to an added aspect of the disclosure, in response to determining that the second facial expression 344 of the at least one first individual is an acceptable facial expression, electronic device 100 initiates capture of the first persistent image 370 of the at least one first individual via rear main camera 152b1.

According to a further aspect of the disclosure, electronic device 100 presents a first graphical user interface (GUI) 450 on front display 161A. The first GUI 450 includes at least a portion of the first preview image stream 332 captured via the rear main camera 152b1 and an notification or indicator 452 identifying the at least one first individual 430 whose image is to be captured does not have the first facial expression that corresponds to an acceptable facial expression for initiating image capture.

FIGS. 7A-7B depict method 700 by which electronic device 100 selects at least one animation to present during image capturing based on subject facial expression. The description of method 700 will be described with reference to the components and examples of FIGS. 1-6B. The operations depicted in FIGS. 7A-7B can be performed by electronic device 100 or any suitable electronic device that includes the one or more functional components of electronic device 100 that provide/enable the described features. One or more of the processes of the methods described in FIGS. 7A-7B may be performed by processor 112 executing program code associated with ASIC module 125.

With specific reference to FIG. 7A, method 700 begins at the start block. At block 702, method 700 includes detecting that electronic device 100 is in a first image capturing mode using rear main camera 152b1. Method 700 includes presenting a first animation 362 from among a plurality of animations 360 on rear display 161B (block 704). The first animation 362 is intended to attract the attention of at least one first individual 430 whose image is to be captured. Method 700 includes capturing a first preview image stream 332 via the rear main camera 152b1 (block 706) and extracting a first preview image 332A from the first preview image stream 332 (block 708).

Method 700 includes determining if the first preview image 332A contains a face 432 of at least one first individual 430 (decision block 710). In response to determining that the first preview image 332A does not contain a face 432, method 700 ends at the end block. In response to determining that the first preview image 332A contains a face 432, method 700 identifies a first facial expression 342 corresponding to the face 432 in the first preview image 332A (block 712). Method 700 includes determining if the first facial expression 342 corresponds to at least one acceptable facial expression (e.g., first acceptable facial expression 352) for initiating capture of a first persistent image 370 of the at least one first individual (decision block 714). In response to determining that the first facial expression 342 corresponds to an acceptable facial expression (e.g., first acceptable facial expression 352), method 700 includes initiating capture of the first persistent image 370 of the at least one first individual via the rear main camera 152b1 (block 720) and storing the first persistent image 370 to memory subsystem 120 (block 722). Method 700 terminates at the end block.

In response to determining that the first facial expression 342 does not correspond to an acceptable facial expression (e.g., first acceptable facial expression 352) for initiating capture of a persistent image, method 700 includes selecting a second animation 364 from among the plurality of animations 360. (block 716) The second animation 364 is selected to prompt the at least one first individual 430 to respond with a different facial expression. Method 700 includes rendering and presenting the second animation 364 on the rear display 161B where the second animation can be viewed by individual 430 (block 718). Method 700 then transitions to FIG. 7B.

With reference to FIG. 7B, at block 730, method 700 includes capturing a second preview image stream 334 via the rear main camera 152b1. Method 700 includes extracting a second preview image 334A from the second preview image stream 334 (block 732). Method 700 includes determining if the second preview image 334A contains a face 432 of at least one first individual 430 (decision block 734). In response to determining that the second preview image 334A does not contain a face 432, method 700 ends at the end block. In response to determining that the second preview image 334A contains a face 432, method 700 identifies a second facial expression 344 corresponding to the face 432 in the second preview image 334A (block 736).

Method 700 includes determining if the second facial expression 344 corresponds to at least one acceptable facial expression (e.g., first acceptable facial expression 352) for initiating capture of a first persistent image 370 of the at least one first individual (decision block 738). In response to determining that the second facial expression 344 corresponds to an acceptable facial expression (e.g., first acceptable facial expression 352), method 700 includes initiating capture of the first persistent image 370 of the at least one first individual via the rear main camera 152b1 (block 744) and storing the first persistent image 370 to memory subsystem 120 (block 746). Method 700 terminates at the end block.

In response to determining that the second facial expression 344 does not correspond to an acceptable facial expression (e.g., first acceptable facial expression 352), method 700 includes selecting a third animation 366 from among the plurality of animations 360. (block 740) The third animation 366 is selected to prompt the at least one first individual 430 to respond with a different facial expression. Method 700 includes rendering and presenting the third animation 366 on the rear display 161B where the second animation can be viewed by individual 430 (block 742). Method 700 includes presenting a notification 452 to user 410 on display 161A and a notification to subject 430 on display 161B that the subject does not have an acceptable facial expression for image capture after viewing several animations (block 750). Method 700 ends at the end block.

The disclosure provides improvements in the use of cameras within an electronic device by enabling an electronic device to determine if a subject whose image is being captured by a camera has a facial expression that is an acceptable facial expression for capturing an image of the subject. Additional benefits include enabling an electronic device to select an animation from among several animations and present the animation on a display to prompt the individual to respond with a different facial expression. Further, the disclosure enables an electronic device to autonomously capture an image, when the subject whose image is being captured has an acceptable facial expression, such as a smiling facial expression.

In the above-described methods of FIGS. 7A-7B, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one camera, including a first camera having a first field of view (FOV);
at least one display, including a first display oriented in a common first direction with the first FOV of the first camera;
a memory having stored thereon an animation selection and image capture (ASIC) module for enabling selection of at least one animation to present during image capturing; and
at least one processor communicatively coupled to each of the at least one display, the at least one camera, and the memory, and which executes program code of the ASIC module, the at least one processor configured to cause the electronic device to:
while the electronic device is in a first image capturing mode using the first camera, present a first animation, from among a plurality of animations, on the first display, the first animation intended to attract the attention of at least one first individual whose image is to be captured;
extract a first preview image from a first preview image stream being captured via the first camera;
determine if the first preview image contains a face of the at least one first individual with a first facial expression that is an acceptable facial expression for initiating capture of a first persistent image of the at least one first individual; and
in response to determining that the first facial expression of the at least one first individual is not an acceptable facial expression for initiating capture of the first persistent image: select a second animation from among the plurality of animations, the second animation selected to prompt the at least one first individual to respond with a different facial expression; and present the second animation on the first display.

2. The electronic device of claim 1, wherein, to determine if the first preview image contains the face of the at least one first individual with the first facial expression, the at least one processor is configured to cause the electronic device to:
identify that the face of the at least one first individual is captured within the first preview image;
analyze, using comparative facial expression data, the first facial expression of the at least one first individual to determine if the first facial expression of the at least one first individual corresponds to at least one acceptable facial expression from among a plurality of acceptable facial expressions; and
in response to determining that the first facial expression of the at least one individual corresponds to the at least one acceptable facial expression from among the plurality of acceptable facial expressions, initiate capture of the first persistent image of the at least one first individual via the first camera.

3. The electronic device of claim 1, wherein the at least one processor is configured to cause the electronic device to:
in response to determining that the first facial expression of the at least one individual is an acceptable facial expression, initiate capture of the first persistent image of the at least one first individual via the first camera.

4. The electronic device of claim 1, wherein the at least one processor is configured to cause the electronic device to:
following a rendering and presenting of the second animation on the first display:
capture a second image preview, using the first camera;
identify a second facial expression of the at least one first individual from the second image preview;
determine if the second facial expression of the at least one first individual is an acceptable facial expression for initiating capture of the first persistent image of the at least one first individual; and
in response to determining that the second facial expression of the at least one first individual is not an acceptable facial expression: select a third animation from among the plurality of animations; and present the third animation on the first display.

5. The electronic device of claim 4, wherein the at least one processor is configured to cause the electronic device to:
in response to determining that the second facial expression of the at least one first individual is an acceptable facial expression, initiate capture of the first persistent image of the at least one first individual via the first camera.

6. The electronic device of claim 1, wherein, to determine if the first preview image contains the face of the at least one first individual with the first facial expression, the at least one processor is configured to cause the electronic device to:
process the first preview image containing the face of the at least one individual through an artificial intelligence engine to identify the first facial expression of the at least one individual.

7. The electronic device of claim 1, wherein an acceptable facial expression for initiating capture of the first persistent image corresponds to a smiling facial expression.

8. The electronic device of claim 1, wherein the first display and the first camera are disposed on a first side of the electronic device and the electronic device further comprises:
a second display disposed on a second side of the electronic device, opposed to the first side, the second display communicatively coupled to the at least one processor, and wherein the at least one processor is configured to cause the electronic device to:
present a first graphical user interface (GUI) on the second display, the first GUI including at least a portion of the first preview image stream captured via the first camera and a first indicator identifying the at least one first individual whose image is to be captured does not have the first facial expression that corresponds to an acceptable facial expression for initiating image capture.

9. A method comprising:
while an electronic device is in a first image capturing mode using a first camera:
presenting a first animation, via at least one processor, from among a plurality of animations on a first display, the first animation intended to attract the attention of at least one first individual whose image is to be captured;
extracting a first preview image from a first preview image stream being captured via the first camera;
determining if the first preview image contains a face of the at least one first individual with a first facial expression that is an acceptable facial expression for initiating capture of a first persistent image of the at least one first individual; and
in response to determining that the first facial expression of the at least one first individual is not an acceptable facial expression for initiating capture of the first persistent image: selecting a second animation from among the plurality of animations, the second animation selected to prompt the at least one first individual to respond with a different facial expression; and presenting the second animation on the first display.

10. The method of claim 9, wherein determining if the first preview image contains the face of the at least one first individual with the first facial expression comprises:
identifying that the face of the at least one first individual is captured within the first preview image;
analyzing, using comparative facial expression data, the first facial expression of the at least one first individual to determine if the first facial expression of the at least one first individual corresponds to at least one acceptable facial expression from among a plurality of acceptable facial expressions; and
in response to determining that the first facial expression of the at least one individual corresponds to the at least one acceptable facial expression from among the plurality of acceptable facial expressions, initiating capture of the first persistent image of the at least one first individual via the first camera.

11. The method of claim 9, further comprising:
in response to determining that the first facial expression of the at least one individual is an acceptable facial expression, initiating capture of the first persistent image of the at least one first individual via the first camera.

12. The method of claim 9, further comprising:
following a rendering and presenting of the second animation on the first display:
capturing a second image preview, using the first camera;
identifying a second facial expression of the at least one first individual from the second image preview;
determining if the second facial expression of the at least one first individual is an acceptable facial expression for initiating capture of the first persistent image of the at least one first individual; and
in response to determining that the second facial expression of the at least one first individual is not an acceptable facial expression: selecting a third animation from among the plurality of animations; and presenting the third animation on the first display.

13. The method of claim 12, further comprising:
in response to determining that the second facial expression of the at least one first individual is an acceptable facial expression, initiating capture of the first persistent image of the at least one first individual via the first camera.

14. The method of claim 9, wherein determining if the first preview image contains the face of the at least one first individual with the first facial expression comprises:
processing the first preview image containing the face of the at least one individual through an artificial intelligence engine to identify the first facial expression of the at least one individual.

15. The method of claim 9, wherein an acceptable facial expression for initiating capture of the first persistent image corresponds to a smiling facial expression.

16. The method of claim 9, further comprising:
presenting a first graphical user interface (GUI) on a second display, the first GUI including at least a portion of the first preview image stream captured via the first camera and a first indicator identifying the at least one first individual whose image is to be captured does not have the first facial expression that corresponds to an acceptable facial expression for initiating image capture.

17. A computer program product comprising:
a computer readable storage device having stored thereon program code which, when executed by at least one processor of an electronic device having at least one camera and at least one display, configures the electronic device to complete the functionality of:
while the electronic device is in a first image capturing mode using a first camera:
presenting a first animation from among a plurality of animations on a first display, the first animation intended to attract the attention of at least one first individual whose image is to be captured;
extracting a first preview image from a first preview image stream being captured via the first camera;
determining if the first preview image contains a face of the at least one first individual with a first facial expression that is an acceptable facial expression for initiating capture of a first persistent image of the at least one first individual; and
in response to determining that the first facial expression of the at least one first individual is not an acceptable facial expression for initiating capture of the first persistent image: selecting a second animation from among the plurality of animations, the second animation selected to prompt the at least one first individual to respond with a different facial expression; and presenting the second animation on the first display.

18. The computer program product of claim 17, wherein to determine if the first preview image contains the face of the at least one first individual with the first facial expression, the program code further configures the electronic device to complete the functionality of:
identifying that the face of the at least one first individual is captured within the first preview image;
analyzing, using comparative facial expression data, the first facial expression of the at least one first individual to determine if the first facial expression of the at least one first individual corresponds to at least one acceptable facial expression from among a plurality of acceptable facial expressions; and
in response to determining that the first facial expression of the at least one individual corresponds to the at least one acceptable facial expression from among the plurality of acceptable facial expressions, initiating capture of the first persistent image of the at least one first individual via the first camera.

19. The computer program product of claim 17, wherein the program code further configures the electronic device to complete the functionality of:
in response to determining that the first facial expression of the at least one individual is an acceptable facial expression, initiating capture of the first persistent image of the at least one first individual via the first camera.

20. The computer program product of claim 17, wherein the program code further configures the electronic device to complete the functionality of:
following a rendering and presenting of the second animation on the first display:
capturing a second image preview, using the first camera;
identifying a second facial expression of the at least one first individual from the second image preview;
determining if the second facial expression of the at least one first individual is an acceptable facial expression for initiating capture of the first persistent image of the at least one first individual; and
in response to determining that the second facial expression of the at least one first individual is not an acceptable facial expression: selecting a third animation from among the plurality of animations; and presenting the third animation on the first display.
